(19) United States
(12) Patent Application Publication
(10) Pub. No.: US 2008/0189236 A1
(43) Pub. Date: Aug. 7, 2008

(54) Monitoring a delivery chain network

(75) Inventors: Earnest J. Foster, Troy, MI (US); Lynn T. Truss, Royal Oak, MI (US); Jeffrey D. Tew, Rochester, MI (US); David A. Field, Birmingham, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/669,978

(22) Filed: Feb. 1, 2007

(51) Int. Cl. G06F 7/00

(52) U.S. Cl. 707/1

(57) ABSTRACT

Methods, systems and computer program products for monitoring a delivery chain network. An exemplary method includes accessing a database of delivery records. Each delivery record includes delivery characteristics including delivery time data for an item transported along a route. A group of delivery records having one or more specified delivery characteristics is selected from the database. The selected group includes delivery records for items transported along at least two different routes. The delivery time data for the group of delivery records is averaged to calculate bundled chart data. The bundled chart data is then output.

### BACKGROUND OF THE INVENTION

The present disclosure relates generally to delivery chain networks, and more specifically to monitoring a delivery chain network.

Delivery chain networks play a critical role in the manufacture and delivery of goods. In logistics chains that have a number of participants, the management and timely co-ordination of services can be complex. As an item is moved from point-to-point, it is often desirable to track the movement of the item, recording information such as the time it takes for the item to move between each location. The movement of an item from point-to-point may be part of a delivery chain network, where an item is manufactured in one location, and then transferred to another location. The movement of an item through a delivery chain network may involve a route that includes multiple segments between an origin and a final destination. Various carriers may be used to transport an item between each segment along a route. As multiple items are moved from the origin to the destination, different routes may be used depending on factors such as capacity of carriers, cost, and level of urgency in moving the items from the origin to the destination. Typically, a greater distance between the origin and the destination results in a greater number of possible routes in the delivery chain network; however, many routes may share common segments.

It is often desirable to monitor the efficiency of each route to increase accuracy in estimating a delivery time or shipping cost. Developing tracking statistics associated with each route may also aid in setting terms during contract formation between suppliers, carriers, and recipients of items at the final destination. As many items move to various destinations using multiple routes, the task of developing meaningful tracking statistics and using the statistics can become quite cumbersome. Current methods focus on tracking data for limited routes to reduce the burden of analyzing large volumes of data. This results in incomplete data and possibly faulty tracking statistics. Other methods generate delivery statistics for individual routes but do not group the data to support monitoring the performance of similar routes for irregularities in lead-time performance. Accordingly, there is a need in the art for an improved method of monitoring the delivery performance along routes within a delivery chain network.

### BRIEF DESCRIPTION OF THE INVENTION

An exemplary embodiment includes a method for monitoring a delivery chain network. The method includes accessing a database of delivery records. Each delivery record includes delivery characteristics including delivery time data for an item transported along a route. A group of delivery records having one or more specified delivery characteristics is selected from the database. The selected group includes delivery records for items transported along at least two different routes. The delivery time data for the group of delivery records is averaged to calculate bundled chart data. The bundled chart data is then output.

Another exemplary embodiment includes a system for monitoring a delivery chain network. The system includes a data management system for maintaining a database of delivery records. The system also includes a processing circuit in communication with the data management system and including computer instructions to implement a delivery analysis tool. The delivery analysis tool facilitates accessing the database of delivery records. Each delivery record includes delivery characteristics including delivery time data for an item transported along a route. A group of delivery records having one or more specified delivery characteristics are selected from the database. The selected group includes delivery records for items transported along at least two different routes. The delivery time data for the group of delivery records is averaged to calculate bundled chart data. The bundled chart data is then output.

A further exemplary embodiment includes a computer program product for monitoring a delivery chain network. The computer program product includes a storage medium readable by a processing circuit and storing instructions for execution by the processing circuit for performing a method. The method includes accessing a database of delivery records. Each delivery record includes delivery characteristics including delivery time data for an item transported along a route. A group of delivery records having one or more specified delivery characteristics is selected from the database. The selected group includes delivery records for items transported along at least two different routes. The delivery time data for the group of delivery records is averaged to calculate bundled chart data. The bundled chart data is then output.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring to the exemplary drawings wherein like elements are numbered alike in the accompanying Figures:

FIG. 1 depicts an exemplary system for monitoring a delivery chain network that may be utilized by exemplary embodiments;

FIG. 2 depicts an exemplary process flow that may be implemented by exemplary embodiments to monitor a delivery chain network;

FIG. 3A depicts an exemplary group of related routes between a common origin and four different destinations;

FIG. 3B depicts an exemplary control chart for a first route in exemplary embodiments;

FIG. 3C depicts an exemplary control chart for a second route in exemplary embodiments;

FIG. 3D depicts an exemplary control chart for a third route in exemplary embodiments;

FIG. 3E depicts an exemplary control chart for a fourth route in exemplary embodiments;

FIG. 3F depicts an exemplary control chart for a bundle of routes in exemplary embodiments;

FIG. 4 depicts a user interface that may be implemented by exemplary embodiments; and

FIG. 5 depicts a user interface that may be implemented by exemplary embodiments.

### DETAILED DESCRIPTION OF THE INVENTION

Exemplary embodiments, as shown and described by the various figures and the accompanying text, provide methods, systems and computer program products for monitoring a delivery chain network. A delivery chain network refers to a series of interconnected point-to-point transfers used to move an item from an origin to a destination. A delivery chain network may include multiple points of origin, multiple points of destination, or both, such as an automotive manufacturer with multiple production facilities and multiple dealers. A delivery chain network may also include holding locations, such as a warehouse, a lot, or a shipping dock. Items move through a delivery chain network between an origin and a destination along a route, which may include multiple segments. For example, an item may be moved by a truck to a freight train, carried by the freight train to a distribution hub, and transported from the distribution hub by a truck to the final destination. The distance traveled by each carrier represents a segment of the route. The distance traveled and duration of each segment may vary substantially. For example, a freight train may rapidly transport an item between points as compared to the time between entering and exiting a storage facility.

There may be multiple possible routes for an item to travel through a delivery chain network, and some routes may share common segments. For example, a manufacturer in Michigan may ship four items to Texas, with final destinations of Dallas, Fort Worth, Austin, and Houston. Each of the items may be transported on common segments from Michigan to a Texas distribution hub, with the only difference between each route occurring at the final segment, as each item is delivered from the distribution hub to its respective final destination. At each transfer and storage point along each segment of a route through a delivery chain network, information may be logged for each item. The information may include an identifier for each item or collection of items as well as a time stamp. Each time stamp logged for each segment of a route may be used to determine the length of time that it took to move an item through the segment, herein referred to as a segment time. The delivery time for a route may be calculated as a summation of all segment times for a route. Delivery data associated with the delivery of an item via a route through a delivery chain network may be stored in an origin-destination pair (OD pair). An OD pair may include delivery characteristics such as the delivery time data and other information for each segment of the route, such as, but not limited to, segment time and date, segment end points, transportation activity type, and carriers.

In exemplary embodiments, OD pairs may be grouped as an OD bundle based upon common delivery characteristics for routes or segments. An OD bundle may include sets of OD pairs with largely common transportation routes or carriers. OD pairs may be further aggregated on other criteria such as transportation activity type for segments using truck transport, rail transport, or other activity types. Other types of aggregation of OD pairs may be based upon particular carriers or upon time characteristics, such as day of the week. OD bundling and aggregation reduce larger volumes of partially related data, such as data from all routes, to a smaller number of related data sets, while also providing more data for statistical analysis than is present in a single data set, such as a single route.

In order to derive meaningful information from a collection of data, such as OD pairs, it is useful to perform statistical analysis to produce summary statistics and charts. Statistical process control (SPC) is often used in a manufacturing environment, where processes are repetitious, to monitor critical characteristics for variations in excess of control limits. As part of SPC, one type of chart that is valuable in monitoring for variations in a process over a period of time is a control chart. A control chart typically includes a centerline, an upper and a lower control limit, and data points representing a characteristic of a process under observation. The centerline in a control chart represents the mean of the data points collected over a period of time. The control limits are typically an upper and lower limit centered about the centerline at distance equivalent to a multiple of a standard deviation. Both the mean and the standard deviation of the data may be calculated periodically when a sufficient number of data points have been collected and may be recalculated after an event causes a shift in the performance of the process.

Similar to manufacturing processes, other processes may utilize control charts to monitor the behavior of a critical parameter, such as delivery time for a route through a delivery chain network. As multiple shipments of one or more items use the same route over a period of time, it is possible to monitor and predict the performance of the process using a control chart. Control limits may be set for the route to establish trip points that may indicate a problem with the process. For example a given route may take an average of ten days. The route may have lower and upper control limits of nine and eleven days respectively. When a shipment on the route takes twelve days, an alarm may be tripped to indicate that a control limit has been exceeded. The fact that a control limit has been exceeded may or may not indicate a problem with the process. In random processes, it is normal and expected that control limits will occasionally be exceeded, resulting in outlier points.

Multiple data sets, such as an OD bundle, collected over a period of time may be averaged and analyzed as a group when the data is statistically similar. An OD bundle may include statistically similar data, since the OD bundle includes data from common segments between the bundled routes. When multiple data sets are aggregated and averaged, the effect of outliers is diminished relative to the entire set. The removal of outliers through averaging may reduce the number of false alarms that would otherwise be triggered by an occasional exceedance of a control limit in an individual route of the OD bundle. When processes are closely related, a shift in a process may result in shifts across multiple process data sets. Process shifts may occur where delays are systemic, such as when long-term road construction results in slowing deliveries over a period of time, rather than random occurrences, such as a breakdown of a single truck. Averaging multiple data sets, such as the data contained within an OD bundle, captures the broader effects and trends, while filtering out control limit exceedances isolated to a single data set. The average of the data in an OD bundle is referred to as a bundled chart data.

The bundled chart data may have unique control limits, as the distribution of data should be less than that of an individual route due to the averaging of multiple data sets. When an exceedance of a control limit for the bundled chart data occurs, this may indicate a substantial problem with an individual underlying route or a systemic problem across multiple underlying routes. The bundled chart data may be used to generate statistics and charts such as Pareto charts, histograms, analysis of variance (ANOVA), capability measures, and other similar statistics and charts known in the art.

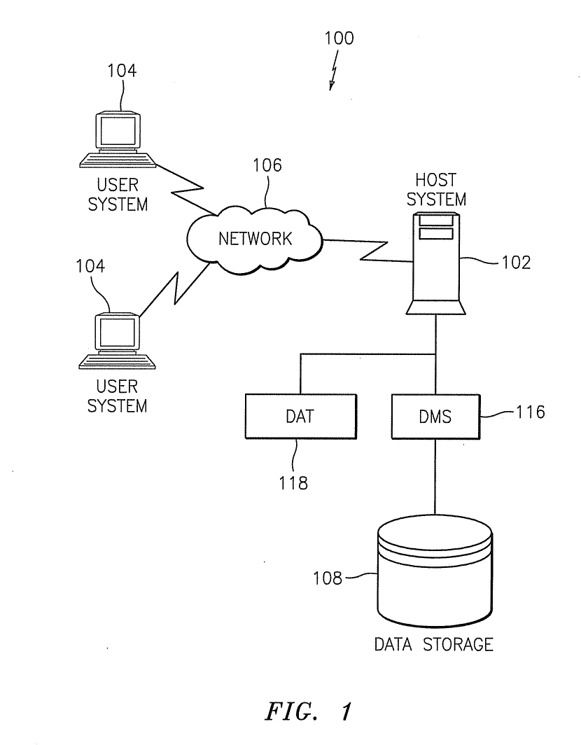

Turning now to the drawings, it will be seen that in FIG. 1 there is a block diagram of a system upon which monitoring of a delivery chain is implemented in exemplary embodiments. The system 100 of FIG. 1 includes a host system 102 in communication with user systems 104 over a network 106. The host system 102 may be a high-speed processing device (e.g., a mainframe computer) that handles large volumes of processing requests from user systems 104. In exemplary embodiments, the host system 102 functions as an application server and a database management server. User systems 104 may comprise desktop or general-purpose computer devices that generate data and processing requests, such as logging delivery data or requesting delivery data reports. In addition, all or a portion of the processing described herein may be executed on one or more of the user systems 104 and all or a portion of the data utilized by the processing may be stored on the user systems 104. While only a single host system 102 is shown in FIG. 1, it will be understood that multiple host systems may be implemented, each in communication with one another via direct coupling or via one or more networks. For example, multiple host systems may be interconnected through a distributed network architecture. The single host system 102 may also represent a cluster of hosts accessing a common data store, e.g., via a clustered file system that is backed by a data storage device 108.

The network 106 may be any type of communications network known in the art. For example, the network 106 may be an intranet, extranet, or an internetwork, such as the Internet, or a combination thereof. The network 106 may be a wireless or wireline network.

The data storage device 108 refers to any type of storage and may comprise a secondary storage element, e.g., hard disk drive, tape, or a storage subsystem that is external to the host system 102. Types of data that may be stored in data storage device 108 include databases with tables, records, queries, or reports of deliveries and transit routes for various items. In exemplary embodiments, a database of delivery records is stored in the data storage device 108. It will be understood that the data storage device 108 shown in FIG. 1 is provided for purposes of simplification and ease of explanation and is not to be construed as limiting in scope. To the contrary, there may be multiple data storage devices utilized by the host system 102.

In exemplary embodiments, all or part of the data in the database of delivery records is sourced from RFID readers (e.g., reading data from RFID devices on items being transported). Monitoring the movements of materials (or items) provides operational data for efficient management of plants and long supply lines. By placing RFID devices on containers carrying material, monitoring the movement of the containers with strategically placed RFID readers give more accurate and timely data. RFID devices placed along a supply route at intermediate locations such as border crossings, bridges, ports and consolidators may be utilized to provide the arrival and departure times of items being transported along a route.

Accumulating this data for many containers will yield statistical distributions upon which statistical methods can be used to provide value added information on long supply lines. For instance, buffer stock may be reduced, covariate data may be used to choose suppliers of drayage, and accurate estimated times of arrivals for parts would be possible. Alerts can be sent to pertinent parties when an RFID reader collects anomalous data. Furthermore statistical process control can be applied to data to monitor links in the supply chain. Automating the process of collecting and analyzing data with computers can provide up to the minute information and analyses when events occur.

In exemplary embodiments, the host system 102 includes one or more processing circuits to execute various software applications, including a data management system (DMS) 116 and a delivery analysis tool (DAT) 118. Other applications, e.g., business applications, a web server, etc., may also be implemented by the host system 102 as dictated by the needs of the enterprise of the host system 102. The DMS 116 maintains one or more databases (e.g., the delivery record database), controlling read and write accesses to the data storage device 108 in which databases are stored.

The user systems 104 may access the host system 102 to request delivery statistics data or plots. The user systems 104 may also access the host system 102 to enter new delivery data, modify existing queries of delivery data, or add new routes. When the host system 102 receives the request, the host system 102 calls the DMS 116 to retrieve or modify tables, records, queries, or reports stored in a database on data storage device 108. In addition the user systems 104 request that particular data from the DMS 116 be presented via a user interface screen (e.g., a graphical representation on the user system 104) and/or via a report. As described in greater detail herein, the DAT 118 may use bundling to reduce the volume of data reported and to aggregated data sets in performing analysis and monitoring of a delivery chain network. The DAT 118 may work in conjunction with the DMS 116 to manage reporting data requested from the data storage device 108; although, it is understood that the DAT 118 may be incorporated with the DMS 116 as a single entity.

In alternate embodiments, bundling of similar data sets for monitoring process performance may be performed for manufacturing process data. As items are assembled in a plant, they may go through both individual processes based on their respective product line and common processes used for multiple product lines. Each manufacturing process may be viewed as a segment of a delivery chain network. Data may be logged for each step of the manufacturing process. The collected manufacturing process data may be bundled or otherwise aggregated based upon similar characteristics for each process. The bundled manufacturing process data may then be averaged as bundled chart data. Unique control limits may be created for the bundled chart data. The bundled chart data and control limits may then be used to monitor the performance of multiple related processes. As in other types of delivery chain networks, the use of bundled chart data in a manufacturing process may reduce the number of false alarms of process errors.

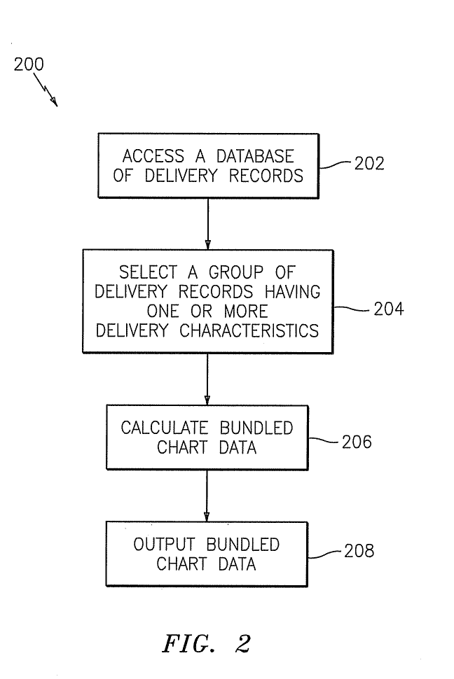

Referring now to FIG. 2, a process flow 200 is depicted for implementing an exemplary embodiment of the invention. In exemplary embodiments, the process flow 200 depicted in FIG. 2 is facilitated by computer instructions in the DAT 118. At block 202, a database of delivery records is accessed. The delivery record database includes delivery characteristic data for items transported along a route in the delivery chain. In exemplary embodiments, the delivery characteristics include delivery time data, carrier name, carrier type, and day of week for one of more segments (designated, for example, by starting points and ending points). Each record represents an “OD pair.” At block 204, a group of delivery records from the delivery record database are selected. The records in the group are selected based on one or more specified delivery characteristics and include items that were transported along at least two different routes. For example, records may be selected because they include a specified carrier type (e.g., trucking, rail) along specified segments (e.g., point A to point B, point B to point C, and point C to point D). These segments may be common to three routes (e.g., route I, route II, and route III). In exemplary embodiments, the specified delivery characteristics are received from a user system 104 and/or are retrieved from the data storage device 108 through the DMS 116. In exemplary embodiments, access to the delivery record database is managed via the DMS 116.

At block 206, the delivery time data for the selected group of routes are averaged to calculate bundled chart data. The delivery time data may be selected over various intervals such as days, weeks, or months. The averaging may be performed on a sample-by-sample basis across each set of delivery time data in the group of routes. For example, the first delivery time datum in each route can be added together and divided by the total number of routes in the group to produce the first bundled chart datum. The averaging may be repeated for each successive datum in the group of routes to produce the complete bundled chart data. In addition, the bundled chart data may be analyzed to determine the mean and standard deviation of the data. In exemplary embodiments the delivery time data are filtered before being averaged. Sometimes errant data may be entered for a delivery time; therefore, a filter may be used to remove errant data values or entire records. The filter process may remove values such as outliers, negative values, and other errant data. The filter process may also remove duplicate records, or attempt to correct the unfiltered data.

At block 208, the bundled chart data is output. The output may be to a graphical display or written to a file. The output to the graphical display or the file may be as a graphical figure, a table, or text. The output may include a centerline approximately equal to the mean of the bundled chart data. The output may also include upper and lower control limits approximately equal to the mean plus or minus a multiple of the standard deviation of the bundled chart data. Other statistics and charts for both the bundled chart data and individual route data may be generated such as Pareto charts, histograms, analysis of variance (ANOVA), capability measures, and other similar statistics and charts known in the art.

The DAT 118 may also enable the user system 104 to vary the level of analysis performed based on selectable bundling and aggregation. For example, the user system 104 may select performance statistics for items sent between Michigan and Texas, and may continue to refine the selection criteria down to a particular city, dealership, or a single item. Comparisons may also be performed between many different destinations, such as comparing delivery statistics for shipments from Michigan to Texas against shipments from Michigan to New York. The flexibility of drilling down or digging deeper into the performance of various routes and segments may better enable managers and logistics specialists in routing deliveries and contracting with both carriers and end recipients of the items being shipped.

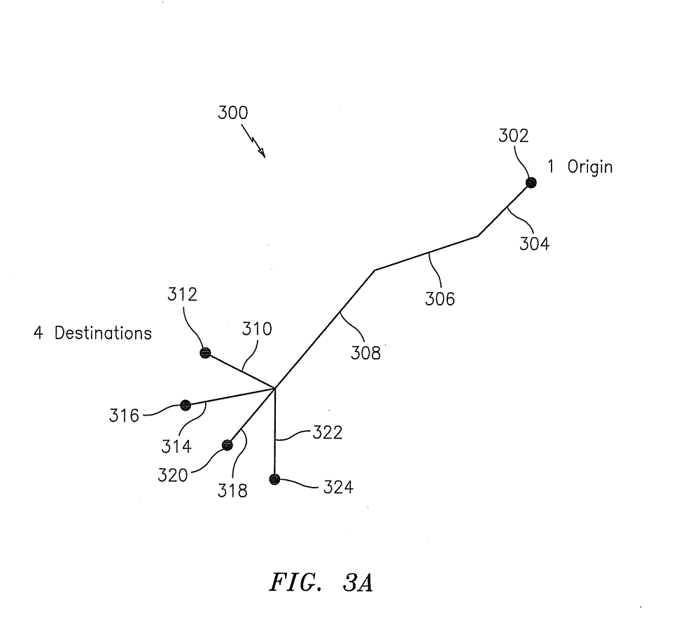

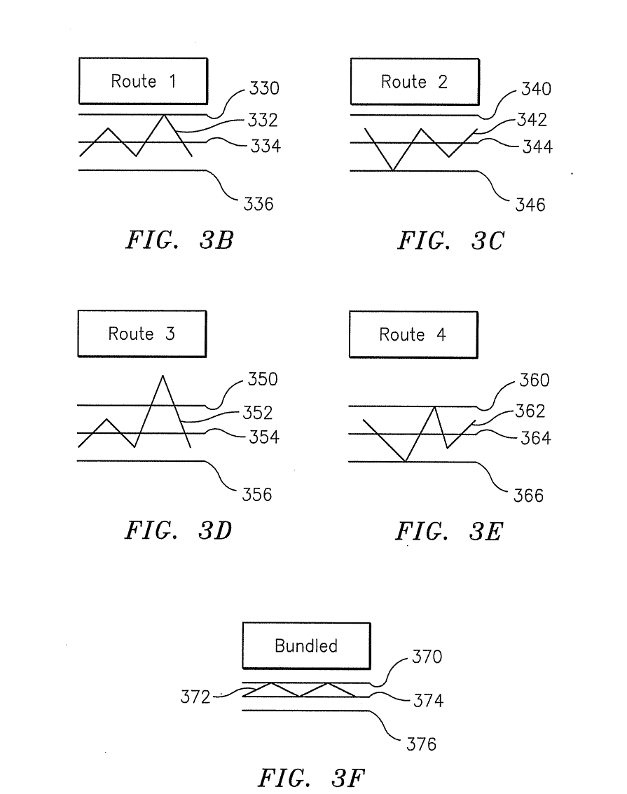

Turning now to FIG. 3A, an example delivery chain network 300 is depicted as a group of four possible routes from a common origin 302 to four different destinations 312, 316, 320, and 324. At the origin 302, multiple items may be manufactured, assembled, purchased, or otherwise acquired prior to moving each item through the delivery chain network 300. A first route, route 1, through delivery chain network 300 from origin 302 to destination 312 includes segments 304, 306, 308, and 310. A second route, route 2, through delivery chain network 300 from origin 302 to destination 316 includes segments 304, 306, 308, and 314. A third route, route 3, through delivery chain network 300 from origin 302 to destination 320 includes segments 304, 306, 308, and 318. A fourth route, route 4, through delivery chain network 300 from origin 302 to destination 324 includes segments 304, 306, 308, and 322. As illustrated in the exemplary delivery chain network 300, there are three common segments 304, 306, and 308 and one unique segment 310, 314, 318, and 322 respectively for each route. In exemplary embodiments, bundling of all four routes in delivery chain network 300 may be performed by DAT 118 to produce bundled chart data for analysis. Although the example delivery chain network 300 depicted in FIG. 3A illustrates four routes with three common segments, this is merely one embodiment of a delivery chain network and should not be viewed as limiting in scope.

Turning now to FIG. 3B, an exemplary control chart for route 1 through the delivery chain network 300 is depicted. The control chart includes an upper control limit 330, a plotted sequence of data 332, a centerline 334, and a lower control limit 336. The DAT 118 may generate the control chart upon a request from the user system 104. The plotted sequence of data 332 may include delivery time data from a series of deliveries over a period of time between the origin 302 and the destination 312. The centerline 334 may be the mean of plotted sequence of the data 332. Alternatively, the centerline 334 may be the mean of a previous data set for the route. The upper control limit 330 may be positively offset from the centerline 334 by a multiple of the standard deviation of the plotted sequence of data 332 or a previous sequence of data for the route. The lower control limit 336 may be negatively offset from the centerline 334 by a multiple of the standard deviation of the plotted sequence of data 332 or a previous sequence of data for the route.

Turning now to FIG. 3C, an exemplary control chart for route 2 through the delivery chain network 300 is depicted. The control chart includes an upper control limit 340, a plotted sequence of data 342, a centerline 344, and a lower control limit 346. DAT 118 may generate the control chart upon a request from user system 104. The plotted sequence of data 342 may include delivery time data from a series of deliveries over a period of time between the origin 302 and the destination 316. The centerline 344 may be the mean of the plotted sequence of data 342. Alternatively, the centerline 344 may be the mean of a previous data set for the route. The upper control limit 340 may be positively offset from the centerline 344 by a multiple of the standard deviation of the plotted sequence of data 342 or a previous sequence of data for the route. The lower control limit 346 may be negatively offset from the centerline 344 by a multiple of the standard deviation of the plotted sequence of data 342 or a previous sequence of data for the route.

Turning now to FIG. 3D, an exemplary control chart for route 3 through the delivery chain network 300 is depicted. The control chart includes an upper control limit 350, a plotted sequence of data 352, a centerline 354, and a lower control limit 356. The DAT 118 may generate the control chart upon a request from user system 104. The plotted sequence of data 352 may include delivery time data from a series of deliveries over a period of time between the origin 302 and the destination 320. The centerline 354 may be the mean of plotted sequence of data 352. Alternatively, the centerline 354 may be the mean of a previous data set for the route. The upper control limit 350 may be positively offset from the centerline 354 by a multiple of the standard deviation of the plotted sequence of data 352 or a previous sequence of data for the route. The lower control limit 356 may be negatively offset from the centerline 354 by a multiple of the standard deviation of the plotted sequence of data 352 or a previous sequence of data for the route.

Turning now to FIG. 3E, an exemplary control chart for route 4 through the delivery chain network 300 is depicted. The control chart includes an upper control limit 360, a plotted sequence of data 362, a centerline 364, and a lower control limit 366. DAT 118 may generate the control chart upon a request from user system 104. The plotted sequence of data 362 may include delivery time data from a series of deliveries over a period of time between the origin 302 and the destination 324. The centerline 364 may be the mean of the plotted sequence of data 362. Alternatively, the centerline 364 may be the mean of a previous data set for the route. The upper control limit 360 may be positively offset from the centerline 364 by a multiple of the standard deviation of the plotted sequence of data 362 or a previous sequence of data for the route. The lower control limit 366 may be negatively offset from the centerline 364 by a multiple of the standard deviation of the plotted sequence of data 362 or a previous sequence of data for the route.

Turning now to FIG. 3F, an exemplary control chart for a bundled group of routes 1-4 through the delivery chain network 300 is depicted. The control chart may be output from the DAT 118 to summarize the performance of routes 1-4 upon a request from the user system 104. The control chart includes an upper control limit 370, a plotted sequence of data 372, a centerline 374, and a lower control limit 376. The plotted sequence of data 372 may include the average of the plotted sequence of data 332, 342, 352, and 362. The centerline 374 may be the mean of plotted sequence of data 372. Alternatively, the centerline 374 may be the mean of a previous data set for the bundled group of routes. The upper control limit 370 may be positively offset from the centerline 374 by a multiple of the standard deviation of the plotted sequence of data 372 or a previous sequence of data for the bundled group of routes. The lower control limit 376 may be negatively offset from the centerline 374 by a multiple of the standard deviation of the plotted sequence of data 372 or a previous sequence of data for the bundled group of routes. In exemplary embodiments, since the control chart of FIG. 3F may effectively summarize the control charts of FIGS. 3B, 3C, 3D, and 3E, users of the DAT 118 may save analysis time by monitoring the performance of a single chart as opposed to the multiple charts that would otherwise be individually analyzed for each route. The DAT 118 may generate the control charts of FIGS. 3B, 3C, 3D, and 3E upon a request from the user system 104.

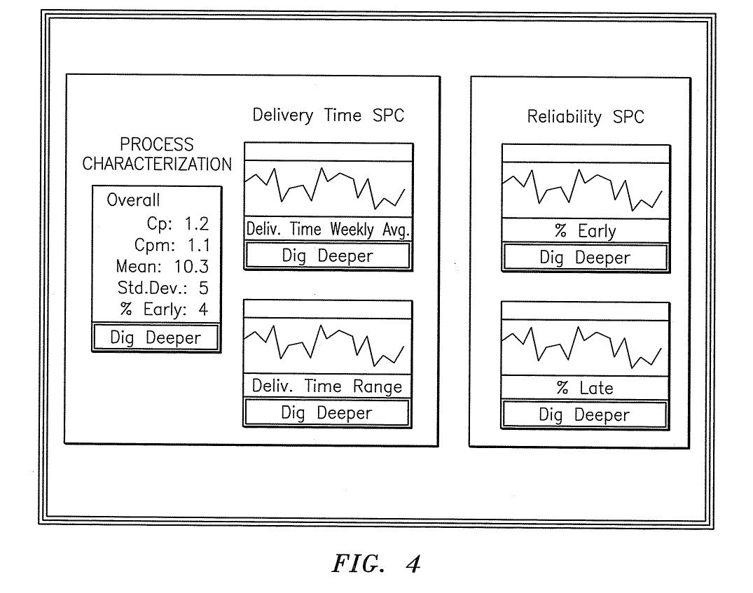

FIG. 4 depicts a graphical user interface that may be implemented by exemplary embodiments of the DAT 118 and presented to a user via a user system 104. FIG. 4 includes a block called “Process Characterization” that summary that includes overall statistical information about the bundled chart data. In the example shown in FIG. 4, the capability measure, “Cp” is equal to 1.2, and the capability measure, “Cpm”, which is commonly called the Taguchi capability index because it takes into consideration the process distance from the target mean and process variance, is equal to 1.1. In addition, the mean delivery time for items in the bundle chart data is 10.3 days, with a standard deviation of 5 days and four percent of the deliveries being completed early.

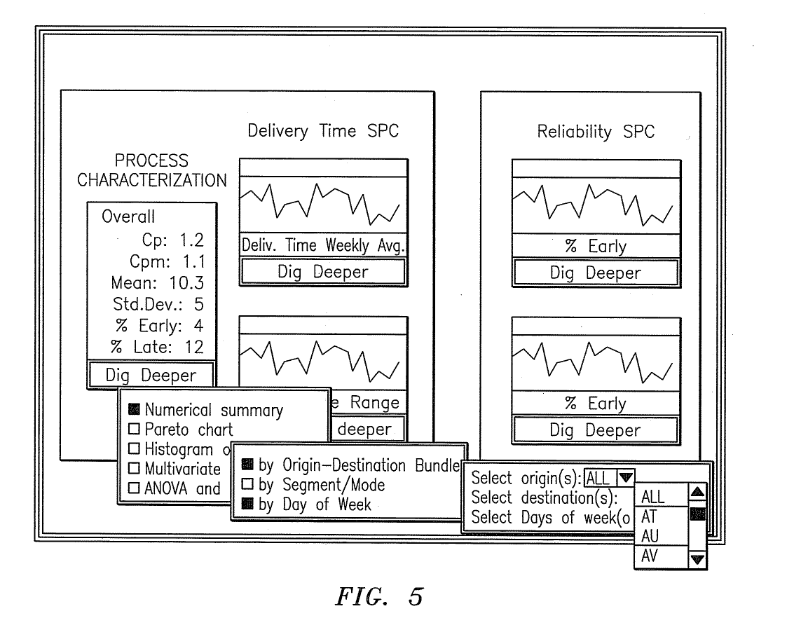

Still referring to FIG. 4, the two blocks under the heading “Delivery Time SPC” depict process control charts for the bundled chart data that includes delivery time data for all items that are transported on the routes within the bundle for a selected week. Any time period that has corresponding delivery time data can be represented in the charts. The selected time period may be a range of dates (e.g., a one week time period, a month, a year, etc.), or alternatively, all of the data available for the routes regardless of date. The top chart is a graphical representation of the average delivery times for days (or other time unit such as hours) in the selected week, bounded by lines that represent an upper and lower control limit. The bottom chart is the delivery time range for the selected week, bounded by lines that represent an upper and lower control limit. Both blocks have an option labeled “Dig Deeper” which will be described later herein in reference to FIG. 5.

Still referring to FIG. 4, the two blocks under the heading “Reliability SPC” depict process control charts for the bundled chart data that includes delivery time data for all items that are transported on the routes within the bundle for a selected week. The top chart is a graphical representation of the percent of deliveries that were early for days (or other time unit such as hours) in the selected week, bounded by lines that represent an upper and lower control limit. The bottom chart is a graphical representation of the percent of deliveries that were late for days (or other time unit such as hours) in the selected week, bounded by lines that represent an upper and lower control limit. Both blocks have an option labeled “Dig Deeper” which will be described later herein in reference to FIG. 5. The user interface screen depicted in FIG. 4 is intended to be one example of a user interface screen for displaying statistical data related to the bundled chart data (also referred to herein as outputting the bundled chart data), other arrangements may be implemented including all, a subset or none of the blocks depicted in FIG. 4 without departing from the scope of the invention.

FIG. 5 is a user interface screen that may be implemented to exemplary embodiments in response to the user selecting the “Dig Deeper” option under the “Process Characterization” heading in FIG. 4. A similar screen would be displayed in response to the user selecting “Dig Deeper” under any of the other blocks depicted in FIG. 4. As shown in FIG. 5, the user may request that the bundled chart data be presented in a different format such as a numerical summary, a Pareto chart, a histogram, and an ANOVA. In addition, the user may request that the bundled chart data be grouped in a different manner such as by origin-destination bundle, by segment/mode (e.g., carrier type), and/or by the day of the week. Further the user may request that the results include a subset of the bundled chart data such as particular origins, particular destinations and/or selected days of the week. In alternate embodiments the user may also request that the subset include particular carriers (i.e., particular carrier identifiers) and/or particular carrier types. Further, the user may select delivery data for one or more of the specific items transported on one of the routes in the bundle of routes.

Embodiments of the invention may be embodied in the form of computer-implemented processes and systems for practicing those processes. The present invention may also be embodied in the form of a computer program product having computer program code containing instructions embodied in tangible media, such as floppy diskettes, CD-ROMs, hard drives, universal serial bus (USB) drives, or any other computer readable storage medium, such as read-only memory (ROM), random access memory (RAM), and erasable-programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes a system for practicing the invention. When implemented on a general-purpose microprocessor, the computer program code segments configure the microprocessor to create specific logic circuits. A technical effect of the executable instructions is to group data, such as delivery time data, from multiple related routes in a delivery chain network. Further technical effects include filtering the data, averaging the data as bundled chart data, and outputting the bundled chart data.

Technical benefits of embodiments of the invention may include: a reduction of the number of control charts for a collection of routes though bundling and aggregation of data; a reduction in false alarms in monitoring delivery time for routes in a delivery chain network through averaging related route data; and providing a method to vary the scope of statistical analysis between summary data at a high level down to specific route, segment, and item tracking. Additional advantages include: grouping data to support monitoring the performance of similar routes for irregularities in lead-time performance; providing statistical data to empower management to make strategic re-routing decisions based on route and segment performance; increasing accuracy in predicting arrival times for items shipped through a delivery chain network; and monitoring carrier performance for compliance with contracts.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

What is claimed is:

1. A method for monitoring a delivery chain network, the method comprising:
accessing a database of delivery records, each delivery record comprising delivery characteristics including delivery time data for an item transported along a route;
selecting a group of delivery records having one or more specified delivery characteristics from the database, the selected group including delivery records for items transported along at least two different routes;
averaging the delivery time data for the group of delivery records to calculate bundled chart data; and
outputting the bundled chart data.

2. The method of claim 1 wherein the specified characteristics include a carrier name or a carrier type.

3. The method of claim 1 wherein each of the routes is made up of a plurality of segments and the specified delivery characteristics include one or more of the segments.

4. The method of claim 1 wherein the delivery characteristics include a day of the week and the specified delivery characteristics include a day of the week.

5. The method of claim 1 further comprising:
developing control limits for the bundled chart data; and
outputting the control limits for the bundled chart data.

6. The method of claim 1 further comprising filtering the delivery time data including:
removing redundant delivery time data in the group of delivery records; and
filtering negative delivery time data in the group of delivery records.

7. The method of claim 1 wherein averaging the delivery time data includes:
adding the delivery time data from each route across the group of routes to form a series of summed data for the group of routes; and
dividing the series of summed data for the group of routes by a total number of routes within the group of routes to produce the bundled chart data.

8. The method of claim 1 wherein the bundled chart data is output to a graphical display.

9. The method of claim 1 wherein the bundled chart data is output to a file.

10. The method of claim 1 further comprising:
receiving a request for delivery characteristics for a selected item; and
outputting the delivery characteristics for the selected item.

11. A system for monitoring a delivery chain network, comprising:
a data management system for maintaining a database of delivery records; and
a processing circuit in communication with the data management system and including computer instructions to implement a delivery analysis tool for facilitating:
accessing the database of delivery records, each delivery record comprising delivery characteristics including delivery time data for an item transported along a route;
selecting a group of delivery records having one or more specified delivery characteristics from the database, the selected group including delivery records for items transported along at least two different routes;
averaging the delivery time data for the group of delivery records to calculate bundled chart data; and
outputting the bundled chart data.

12. The system of claim 11 wherein the specified characteristics include a carrier name or a carrier type.

13. The system of claim 11 wherein each of the routes is made up of a plurality of segments and the specified delivery characteristics include one or more of the segments.

14. The system of claim 11 wherein the delivery characteristics include a day of the week and the specified delivery characteristics include a day of the week.

15. The system of claim 11 wherein the delivery analysis tool further facilitates:
developing control limits for the bundled chart data; and
outputting the control limits for the bundled chart data.

16. The system of claim 11 wherein the delivery analysis tool further facilitates filtering the delivery time data including:
removing redundant delivery time data in the group of delivery records; and
filtering negative delivery time data in the group of delivery records.

17. The system of claim 11 wherein averaging the delivery time data includes:
adding the delivery time data from each route across the group of routes to form a series of summed data for the group of routes; and
dividing the series of summed data for the group of routes by a total number of routes within the group of routes to produce the bundled chart data.

18. The system of claim 11 wherein the bundled chart data is output to one or more of a graphical display and a file.

19. The system of claim 11 wherein the delivery analysis tool further facilitates:
receiving a request for delivery characteristics for a selected item; and
outputting the delivery characteristics for the selected item.

20. A computer program product for monitoring a delivery chain network, the computer program product comprising:
a storage medium readable by a processing circuit and storing instructions for execution by the processing circuit for performing a method comprising:
accessing a database of delivery records, each delivery record comprising delivery characteristics including delivery time data for an item transported along a route;
selecting a group of delivery records having one or more specified delivery characteristics from the database, the selected group including delivery records for items transported along at least two different routes;
averaging the delivery time data for the group of delivery records to calculate bundled chart data; and
outputting the bundled chart data.
